(19) United States
(12) Patent Application Publication
(10) Pub. No.: US 2002/0040407 A1
(43) Pub. Date: Apr. 4, 2002

(54) IP address managing apparatus and method in a switching system

(75) Inventor: Man Keon Oh, Su Weon-city (KR)

Correspondence Address: FLESHNER & KIM, LLP, P.O. Box 221200, Chantilly, VA, 20153-1200, US

(73) Assignee: LG Electronics Inc.

(21) Appl. No.: 09/964,443

(22) Filed: Sep. 28, 2001

(30) Foreign Application Priority Data
Sep. 29, 2000 (KR) 57303/2000

(51) Int. Cl. G06F 15/16

(52) U.S. Cl. 709/245

(57) ABSTRACT

An internet protocol (IP) address management method and system are disclosed, having a switch unit that searches for an idle IP address in a database for allocation to an internet connection system. The internet connection system and the switch unit interconnect a subscriber to an IP service network.

### BACKGROUND OF THE INVENTION

1. Field of the Invention

The present invention relates to a network applique and, in particular, an Internet Protocol (IP) address managing method in a switching system. The invention provides unified management of IP address allocation and return in a database of the switching system. Thereby, the invention prevents IP address exhaustion or idle IP address generation in a number of call connections.

2. Background of the Related Art

Generally, in managing IP addresses in a switching system of the related art, a prearranged number of IP addresses are respectively allocated, by an operator, to internet connection systems. These IP addresses are allocated in sequence, as the internet connection systems make their IP allocation requests.

FIG. 1 is a block diagram illustrating an IP address management apparatus in a switching system of the related art. The IP address management apparatus comprises a subscriber 10, an IP service network 25, and a switching system 20 including a call processing unit 22, a number translating unit 23 and a number of internet connection systems 24a-24n.

The subscriber 10 inputs a number or information by using a telephone or other inputting means for connecting with the IP service network 25. When the subscriber is completely connected through the switching system, the IP service network 25 processes an IP packet to provide an IP service to the pertinent subscriber 10.

In the switching system 20, the call processing unit 22 judges if a call requires an IP address for call processing to the internet connection systems 24a-24n, when the subscriber 10 tries a call connection. The number translating unit 23 is connected with the call processing unit 22 for translating a destination number inputted from the subscriber 10. The internet connection systems 24a-42n are allocated with IP addresses, prearranged by the operator, for connection with the IP service network 25. IP addresses are returned to the call processing unit 22 when the connected call is released.

Referring now to FIG. 2, an IP address managing method for the switching system of the related art will be described. In step S11, the internet connection systems 24a-24n are respectively allocated with IP addresses by the operator. When the subscriber 10 tries a Point-To-Point Protocol (PPP) connection requiring an allocated destination IP address, the destination number is translated to connect the pertinent internet connection system with the subscriber, in step S13. When requested to use the prearranged IP address from the pertinent internet connection system in step S14, the IP addresses are allocated in sequence, according to the number of IP addresses previously allocated by an operator of the switching system 20, in step S11. The subscriber and the IP service network are connected via the allocated IP addresses, thereby providing the IP service to the subscriber in step S15.

When the subscriber requests the termination of the connection with the IP service network, in step S16, the switching system 20 sends a call release request to the internet connection system in step S17. The pertinent internet connection system processes a call release to terminate the internet service, in step S18, and the allocated IP address is returned in the internet connection system in step S19.

However, when PPP traffic is concentrated at one point, the idle addresses may be exhausted.

### SUMMARY OF THE INVENTION

An object of the invention is to solve at least the above problems and/or disadvantages and to provide at least the advantages described hereinafter.

The present invention is proposed to solve the foregoing overall problems. An object of the invention to unify management of the IP address allocation and return of a switching system, under the control of a call processing unit, and thereby prevent IP address exhaustion or idle IP address generation. More particularly, according to the invention, a destination number received from a subscriber is translated and a connection is made to an internet connection system, if the internet call requires an IP address. The internet connection system makes an IP address allocation request to a call processing control unit, which accordingly searches for an idle IP address in a database. The database maintains a unified IP address system that allocates the idle IP address to the internet connection system. The idle IP address is transmitted to the internet connection system, which connects the subscriber and the IP service network via the allocated IP address.

The object of the present invention can be achieved in whole or in part by an IP address managing apparatus comprising a subscriber unit for requesting or providing information; a switch unit connected with the subscriber unit for analyzing subscriber information and searching for an idle IP address in a database to allocate the idle IP address to an internet connection system; and an IP service network unit connected to the switch unit and having at least one router for LAN-to-LAN connection.

The switch unit includes a call processing unit for judging if a call requires an IP address or not and performing a call process to the internet connection system when a subscriber tries a call access. A number translating unit connected with the call processing unit translates a destination number inputted from the subscriber; a database connected to the call processing unit manages the IP address. An internet connection system unit connects to the database to request an IP address allocation for connection with the IP service network and to return the IP address to the database when the connected call is released.

Further, the database searches for the idle address to allocate the pertinent IP address, under the control of a call processing unit, when requested by the internet connection system to allocate the IP address. Also, the database stores an IP address returned from the internet connection system unit when the call is released.

According to another embodiment, the object of the present invention can be achieved in whole or in part by an IP address managing method comprising receiving and translating a destination number from a subscriber; connecting to an internet connection system according to a result of the step of translating; requesting an IP address allocation from the internet connection system to a call processing unit; searching for an idle IP address in a database under the control of the call processing unit in response to the step of requesting; and transmitting the pertinent idle IP address to the internet connection system after the step of searching.

The objects of the invention may be achieved in whole or in part by an internet protocol (IP) switching system, including a database that stores management information regarding IP addresses assigned to the switching system; and a call processing unit that processes a call from a subscriber and interconnects the subscriber with one of a number of internet connection systems, based on call information within the call, wherein the call processing unit maintains a record of idle IP addresses and active IP addresses, which are allocated to a number active calls, within the database.

The objects of the invention may be further achieved in whole or in part by a method of managing internet protocol (IP) address allocation in a switching system, including allocating an idle IP address to an internet connection system when a subscriber requests access to the internet connection system; and indicating in a database record corresponding to the allocated IP address that the allocated IP address is active.

According to the foregoing invention, the database manages IP address allocation and return, under the control of the call processing unit in the switching system, thereby preventing a problem that traffic is concentrated into one point to exhaust the IP addresses when a number of subscribers try connecting or the idle address is generated in the internet connection system with a seldom used connection.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates an IP address management apparatus in a switching system of the related art.

FIG. 2 illustrates an IP address managing method in a switching system of the related art;

FIG. 3 illustrates an apparatus for managing IP addresses in a switching system according to a preferred embodiment of the invention;

FIG. 4 illustrates the detailed structure of a database for managing the IP addresses; and

FIG. 5 illustrates an IP address managing method in a switching system according to another preferred embodiment of the invention.

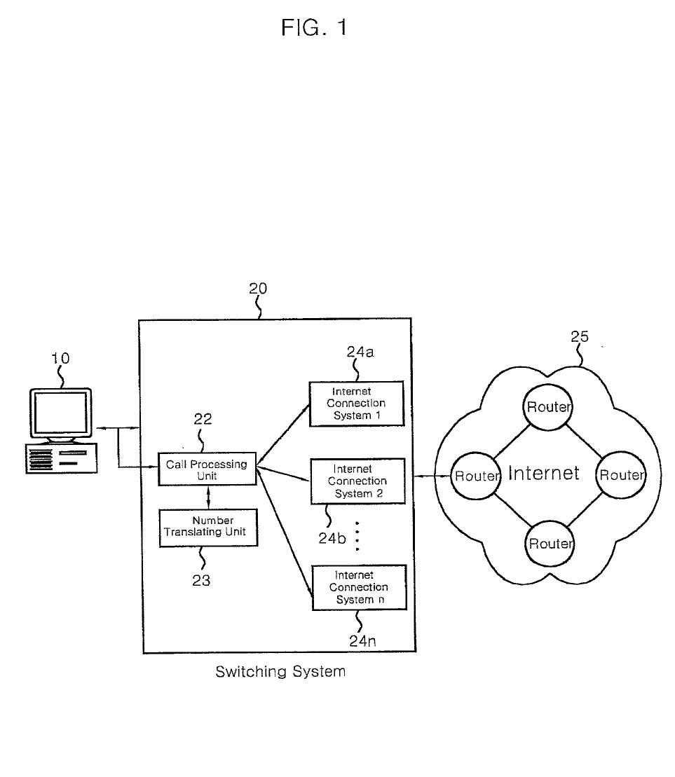

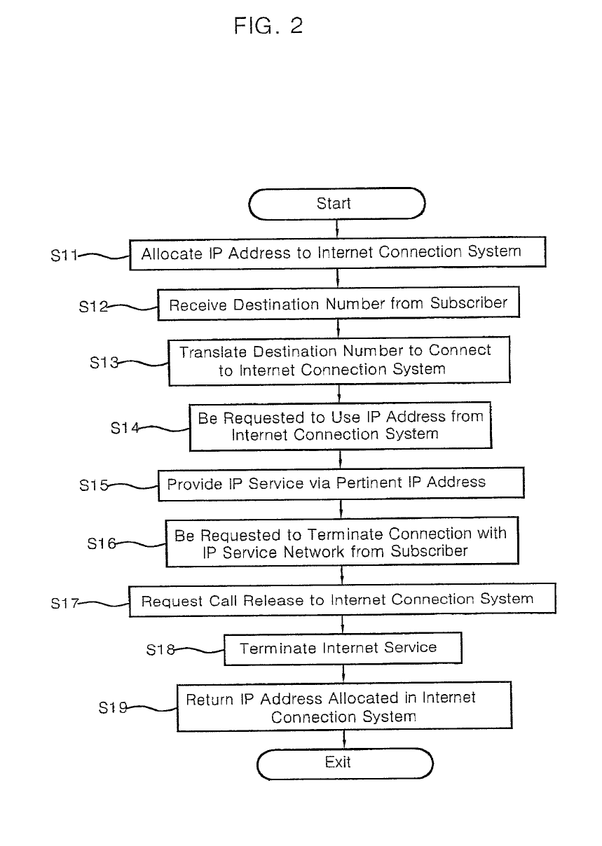

### DETAILED DESCRIPTION OF PREFERRED EMBODIMENTS

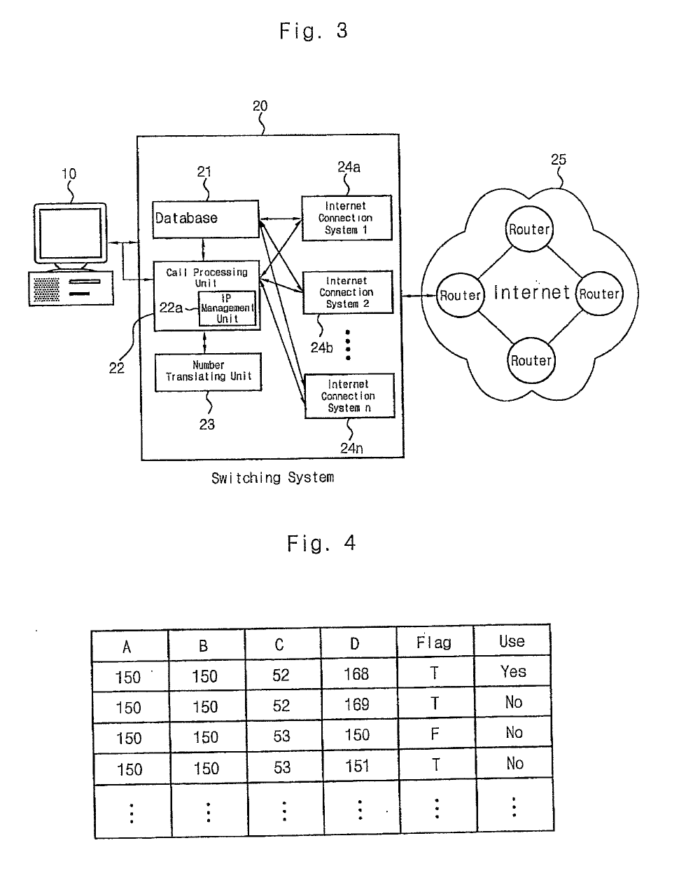

FIG. 3 is a block diagram showing an apparatus for managing IP addresses in a switching system according to a preferred embodiment of the invention. The apparatus comprises a subscriber 10, an IP service network 25, and a switching system 20. The switching system 20 including a database 21, a call processing unit 22, a number translating unit 23 and a number of internet connection system 24a-24n.

The subscriber 10 inputs a number, using a telephone or other inputting means, to obtain a connection with the IP service network 25. When the subscriber is completely connected through the switching system, the IP service network 25 processes an IP packet to provide an IP service to the subscriber 10.

In the switching system 20, the call processing unit 22 judges if a call requires an IP address or not, for call processing to the internet connection systems 24a-24n, when the subscriber 10 tries a call connection. The number translating unit 23 is connected with the call processing unit 22 to translate a destination number inputted from the subscriber 10. Database 21 is connected to the call processing unit 22 and the internet connection systems 24a-24n to manage the IP addresses. Internet connection systems 24a-42n are allocated with IP addresses prearranged by the operator for connection with the IP service network 25 and return the IP addresses when the connected call is released.

When the call processing unit 22 is requested to allocate the IP addresses to internet connection systems 24a-24n, the database 21 searches for idle IP addresses, under the control of the call processing unit 22. These idle IP addresses are allocated to the pertinent internet connection systems. The allocated IP addresses are returned by the pertinent internet connection systems upon terminating the call.

Also, the call processing unit in the switching system can directly control the operation within the switching system or the operation can be controlled by providing an additional control unit or an IP management unit 22a.

FIG. 4 shows the detailed structure of the database 21 for managing IP addresses, in which each of A, B, C and D is an IP class for specifically discriminating each IP address. The Flag field indicates validity/invalidity or true/false of the IP address, and the Use field indicates whether the IP address is currently allocated (indicated as ‘T’) by using Yes or No.

A process of allocating and returning IP addresses, under the control of the call processing unit 22 and the database 21, will be described. In operating the system, a prearranged point indicating the IP address in the database 21 is displayed. If requested to allocate the IP address to the internet connection system, the Flag and Use fields of the identified IP address are searched. IP addresses are allocated in sequence. Also, if requested to return the IP address from the internet connection system, the Flag and Use fields of the IP address, allocated by the allocating process, are reset according to the IP address status.

If the IP address is returned due to a fatal error, the Flag field is set to a value of F and the Use field is set to a value of No. However, if the IP address is returned due to a general reason, instead of the fatal error, the Flag field is set to T and the Use field is set No.

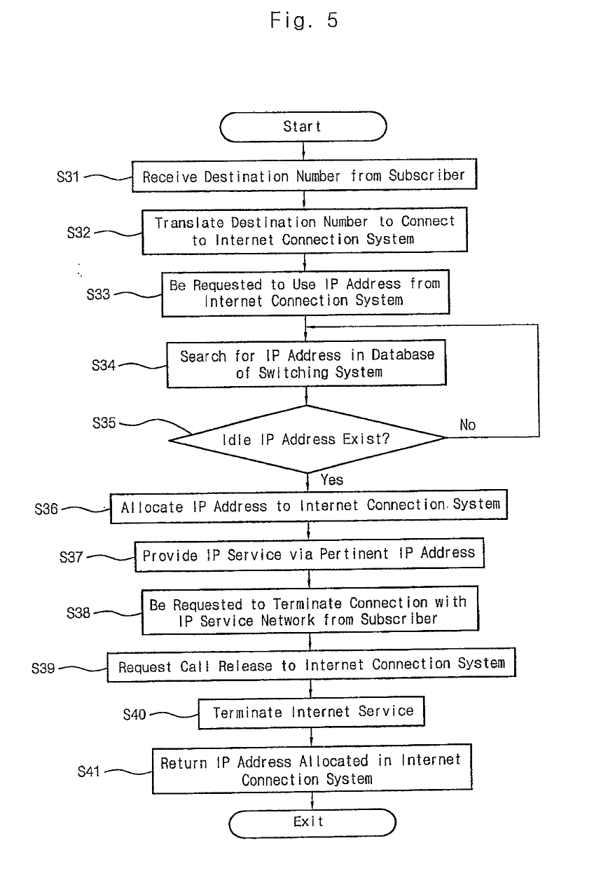

FIG. 5 is a flow chart showing the IP address managing method in the switching system, according to a preferred embodiment of the invention. The subscriber 10 tries a PPP connection requiring the IP address for receiving an internet service. If the destination number received by the call processing unit 22 is one corresponding to a number assigned to an internet connection system, within switching system 20, the call processing unit 22 transmits the destination number to the number translating unit 23 for translation, S31 and S32, and connects to the pertinent internet connection systems 24a-24n.

When the call processing unit 22 is requested by the internet connection system 24a-24n to allocate the IP address for connecting the IP service network 25 with the subscriber 10, in step S33, the idle IP addresses are searched in the database 21, under the control of the call processing unit in step S34. If an idle address exists in the database 21, step S35, it is allocated to the internet connection system 24a-24n, under the control of the call processing unit in step S36. The IP service network 25 and the subscriber 10 are connected via the allocated IP address, thereby providing the IP service to the subscriber 10 in step S37.

When requested to terminate the connection with the IP service network 25, by the pertinent subscriber 10 in step S38, a call release is sent to the internet connection systems 24a-24n, in step S39. The internet services are terminated from the pertinent internet connection system 24a-24n in step S40. IP addresses allocated to the pertinent internet connection system 24a-24n are returned to the database 21, under the control of the call processing unit 22 in step S41.

As described herein, upon receiving the destination number from the subscriber 10, the destination number is translated. If it is judged that the internet call needs the IP address, connection to the internet connection system 24a-24n is performed. The internet connection system sends a request for an IP address to the call processing control unit 22. In response to this request, the call processing unit searches for idle addresses in the database 21 and allocates an idle IP address to the requesting internet connection system 24a-24n.

When a termination of the connection to the IP service network is requested by the pertinent subscriber 10, the call processing unit 22 sends a call release request to the pertinent internet connection system 24a-24n. When the internet service is terminated, the IP address allocated to the pertinent internet connection system is returned to the database, under the control of the call processing unit. Once returned, the IP address is given an idle status.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An internet protocol (IP) address managing apparatus, comprising:
a switch unit that searches for an idle IP address among a plurality of IP addresses stored in a database to allocate the idle IP address to an internet connection system; and
an IP service network unit connected to said switch unit and having at least one router for a LAN-to-LAN connection.

2. The IP address managing apparatus of claim 1, wherein said switch unit comprises:
a call processing unit that determines if a call requires the idle IP address and performs a call process to said internet connection system when a subscriber attempts the call;
a number translating unit connected with said call processing unit that translates a destination number inputted from the subscriber;
a database connected to said call processing unit to manage the plurality of IP addresses; and
the internet connection system unit connected to said database that requests an IP address allocation for connection with said IP service network and returns the IP address allocation to said database when the call is released.

3. The IP address managing apparatus of claim 1, wherein each record of the database corresponds to one of the plurality of IP addresses and each record comprises:
fields A, B, C and D that specifically discriminate the corresponding IP address;
a flag indicating a validity or invalidity of the corresponding IP address; and
a use structure that indicates if the corresponding IP address is being used currently.

4. The IP address managing apparatus of claim 1, wherein said database searches for the idle IP address, under the control of a call processing unit, when said internet connection system requests the call processing control unit to allocate the idle IP address.

5. The IP address managing apparatus of claim 2, further comprising an IP management unit in said call processing unit for managing the plurality of IP addresses in said database.

6. An apparatus for managing internet protocol (IP) addresses, comprising:
an IP service network unit having a router for a LAN-to-LAN connection; and
a switch unit that connects a subscriber to said IP service network, controls a call inputted from said subscriber, searches and allocates an idle IP address in a database according to an IP address allocation request from an internet connection system, and returns a currently used IP address to the database and sets the currently used IP address to be reused, according to an IP return request from said internet connection system.

7. The apparatus of claim 6, wherein said switch unit comprises:
a call processing unit that judges if the call requires an IP address to perform a call process to said internet connection system, when a call connection is attempted by said subscriber;
a number translating unit connected to said call processing unit that translates a destination number inputted from said subscriber;
the database connected to said call processing unit that manages the IP address; and
the internet connection system unit connected to said database that sends the IP address allocation request to said database and returns the IP address to said database when the call is released.

8. The apparatus of claim 6, wherein each record of the database corresponds to one of a plurality of IP addresses and each record comprises:
fields A, B, C and D that specifically discriminate the corresponding IP address;
a flag indicating a validity or invalidity of the corresponding IP address; and
a use structure that indicates if the corresponding IP address is being used currently.

9. The apparatus of claim 6, wherein said database searches for the idle IP address, under the control of a call processing unit, when said internet connection system requests the call processing control unit to allocate the idle IP address.

10. An IP address managing method, comprising:
connecting to an internet connection system identified by a destination number;
requesting IP address allocation from a call processing unit for the internet connection system;
searching for an idle IP address in a database; and
transmitting the idle IP address to the internet connection system.

11. The IP address managing method of claim 10, further comprising connecting a subscriber to an IP service network.

12. The IP address managing method of claim 11, further comprising requesting a call termination by the subscriber.

13. The IP address managing method of claim 12, further comprising:
sending a call release request to the call processing unit from the internet connection system; and
releasing a call from the internet connection system and the IP service network.

14. The IP address managing method of claim 13, further comprising returning the idle IP address to the database, under the control of the call processing unit.

15. The IP address managing method of claim 14, wherein a flag and a use of the idle IP address are reset according to an IP address status, when the idle IP address is returned to the database.

16. The IP address managing method of claim 15, wherein the flag is set to a value of F and the use is set to a value of No, when the idle IP address is returned to the database due to a fatal error, and the flag is set to a value of T and the use is set to a value of No when the idle IP address is returned for a reason other than the fatal error.

17. The IP address managing method of claim 10, wherein an idle IP address list is managed in the database and searched under the control of the call processing unit.

18. The IP address managing method of claim 10, wherein the call processing unit has an additional control unit that searches for the idle IP address in the database.

19. The IP address managing method of claim 10, wherein the idle IP address is identified by state values of a flag and a use of the idle IP address.

20. An internet protocol (IP) switching system, comprising:
a database that stores management information regarding IP addresses assigned to the switching system; and
a call processor for processing a call from a subscriber and for interconnecting the subscriber with one of a number of internet connection systems, based on call information within the call, wherein
the call processor maintains a record of idle IP addresses, which are not allocated, and active IP addresses, which are allocated to a number of active calls, within the database.

21. The switching system of claim 20, further comprising a number translation unit that translates a number within the call information to an identification of a corresponding internet connection system, of the number of internet connection systems.

22. The switching system of claim 20, further comprising:
an IP address record, stored in the database, corresponding to each of a number of IP addresses assigned to the switching system and each IP address record contains a Flag field and a Use field, wherein
the Flag field is set to first value indicating invalidity of the corresponding IP address, if the corresponding IP address is returned to the database due to a fatal error,
the Flag field is set to second value indicating validity of the corresponding IP address, if the corresponding IP address is returned without the fatal error,
the Use field is set to a true value, if the corresponding IP address is currently allocated to an active call, and
the Use field is set to a false value, if the corresponding IP address is not currently allocated to an active call.

23. The switching system of claim 20, wherein the call processor unit searches the database for the idle IP addresses and assigns one of the idle IP addresses to the one internet connection system.

24. A method of managing internet protocol (IP) address allocation in a switching system, comprising:
allocating an idle IP address to an internet connection system when a subscriber requests access to the internet connection system; and
indicating in a database record corresponding to the allocated IP address that the allocated IP address is active.

25. The method of claim 24, further comprising:
indicating in the corresponding database record that the IP address is idle when returned by the internet connection system.

26. The method of claim 24, further comprising:
identifying one of a number of internet connection systems, based on a number received in call information from the subscriber;
connecting the subscriber and the one internet connection system; and
sending an IP address request from the one internet connection system to a database.

27. The method of claim 24, further comprising:
identifying one of a number of internet connection systems, based on a number received in call information from the subscriber;
connecting the subscriber and the one internet connection system;
sending an IP address request from the one internet connection system to a database; and
searching the database, which stores an IP address record for each of a number of IP addresses assigned to the switching system, for one of a number of idle IP addresses that is not currently allocated to the number of internet connection systems.
